(19) United States
(12) Patent Application Publication
(10) Pub. No.: US 2013/0050042 A1
(43) Pub. Date: Feb. 28, 2013

(54) COBRA ANTENNA

(71) Applicants: Yoshitaka Yoshino, Tokyo (JP); Satoru Tsuboi, Kanagawa (JP)

(72) Inventors: Yoshitaka Yoshino, Tokyo (JP); Satoru Tsuboi, Kanagawa (JP)

(73) Assignee: SONY CORPORATION, Tokyo (JP)

(21) Appl. No.: 13/695,384

(22) PCT Filed: Apr. 22, 2011
(86) PCT No.: PCT/JP2011/059912

§ 371 Date: Oct. 30, 2012

(30) Foreign Application Priority Data
May 11, 2010 (JP) 2010-109694

(51) Int. Cl. H01Q 1/00

(52) U.S. Cl. 343/787

(57) ABSTRACT

Provided is a cobra antenna including a relay unit forming a feeding point; an antenna element formed from a plate-like conductor that is electrically connected to one terminal of the relay unit and, when a wavelength of radio waves is represented as λ, has a surface area capable of obtaining a length of λ/4 as a path through which a current generated by reception of the radio waves flows to the one terminal of the relay unit; a coaxial line having one end electrically connected to the other terminal of the relay unit; and a first ferrite core that is provided at a position away from the other terminal of the relay unit to which the one end of the coaxial line is connected by a length of about λ/4, and through which the coaxial line penetrates or is wound around.

### TECHNICAL FIELD

The present invention relates to a cobra antenna, and more particularly, to a technology that can realize a compact antenna capable of handling a wide range of frequency bands from the FM band to the UHF band with a simple configuration.

### BACKGROUND ART

Conventionally, various types of antennas have been used to receive a variety of broadcast waves, such as television broadcasts and FM broadcasts. For example, to receive a television broadcast or an FM broadcast, a dipole antenna, a Yagi-Uda antenna and the like is often used. Meanwhile, there are increasing ways to receive these various broadcast waves or signals carried on such broadcast waves while indoors, in a car, or walking when on the move. An antenna used in such a case needs to be easy to handle (e.g., simple assembly and attachment), and be compact.

A representative example of an antenna that is easy to handle is a dipole antenna that utilizes a simple configuration to realize an antenna element. One known mode of a dipole antenna is a cobra antenna that is used by winding a coaxial cable (coaxial wire) around a ferrite core several times (e.g., Non-Patent Literature 1).

The cobra antenna described in Non-Patent Literature 1 is formed by connecting a line conductor having a length of λ/4 (wherein λ is the wavelength of the received radio waves) as an antenna element to a center conductor (core wire) of an end portion (feeding point) of a coaxial cable on an upper side. Further, a ferrite core is provided a λ/4 distance away from the feeding point on the lower side. The coaxial cable is wound around this ferrite core. Since a choke coil is formed by ferrite core and the coaxial cable wound around the ferrite core, and a feeding portion below the ferrite core is cut away, a λ/4 dipole antenna can be easily produced.

Further, as a compact antenna, a closely-coiled compact antenna has been proposed in which a line conductor is closely coiled in a square shape (e.g., Non-Patent Literature 2). By closely coiling a line conductor in the shape of an open-ended square with an antenna height about 1/13 of the wavelength and a total length about ⅕ of the wavelength, the antenna is more compact and has a simpler configuration. Further, the null depth in the zenith direction of a monopole antenna can be improved.

### CITATION LIST

### Non-Patent Literature

Non-Patent Literature 1: “Wire Antenna”, Edited by CQ ham radio Editorial Department, published by CQ Publishing Co., Ltd., p. 84
Non-Patent Literature 2: “Closely-Coiled Compact Antennas”, Nozomu Hasebe, Kouichi Sakaguchi, Journal of the Institute of Electronics, Information and Communication Engineers (B), published July 2007, Vol. J90-B No. 7, pp. 670-678 (FIG. 1)

### SUMMARY OF INVENTION

### Technical Problem

However, when receiving broadcast waves of 100 MHz, for example, since the wavelength of such broadcast is 3 m, the cobra antenna described in Non-Patent Literature 1 needs to have a length of 0.75 m (λ/4) from the feeding point for the antenna element of only a coaxial cable core wire. Further, the cobra antenna also needs a length of 0.75 m from the feeding point to a high-frequency wave cutoff portion configured by winding the coaxial cable around the ferrite core. Therefore, the total length of the antenna is 1.50 m, which is very large. In order to function as an antenna, since the portion functioning as the antenna needs to be configured so as to not overlap the section between the antenna element and the outer casing of the coaxial wire, there are many restrictions on where the antenna can be installed, such as when routing the antenna to install it in a vehicle, for example.

On the other hand, the closely-coiled compact antenna described in Non-Patent Literature 2 is configured by perpendicularly pulling a conduction element having a total length of about λ/5 from a coaxial center conductor, bending the element midway to be parallel to the ground plane, again pulling the element down in the ground plane direction, then bending the element to be parallel to the ground plane, and finally positioning the element to be parallel with a perpendicular conductor near the feeding point. Although the resonance frequency of this closely-coiled compact antenna depends on the total length L, since the resonance frequency varies based on the interval of a gap s between adjacent elements, the manufacturing needed to be precise.

In view of the above-described circumstances, there is a need for a wide frequency band antenna, for example from the FM band to the UHF band, that is compact and that does not need to be precisely manufactured.

### Solution to Problem

According to the first aspect of the present invention in order to achieve the above-mentioned object, there is provided a cobra antenna including a relay unit forming a feeding point, an antenna element formed from a plate-like conductor that is electrically connected to one terminal of the relay unit and, when a wavelength of radio waves is represented as λ, has a surface area capable of obtaining a length of λ/4 as a path through which a current generated by reception of the radio waves flows to the one terminal of the relay unit, a coaxial line having one end electrically connected to the other terminal of the relay unit, and a first ferrite core that is provided at a position away from the other terminal of the relay unit to which the one end of the coaxial line is connected by a length of about λ/4, and through which the coaxial line penetrates or is wound around.

The plate-shaped conductor of the antenna element connected to the one terminal of the relay unit may be electrically connected to a core line of the coaxial wire at the relay unit.

The plate-shaped conductor of the antenna element may have a rectangular shape that is long in an axial direction of the coaxial wire.

The cobra antenna may further include a second ferrite core for cutting off high-frequency current from the coaxial wire prior to a connector in a receiver to which the other end of the coaxial wire is connected, wherein the second ferrite core has a high impedance to high-frequency waves, and through which the coaxial line penetrates or is wound around.

Further, according to the second aspect of the present invention in order to achieve the above-mentioned object, a cobra antenna includes a relay unit forming a feeding point, an antenna element formed from a spiral-shaped line conductor that is electrically connected to one terminal of the relay unit and, when a wavelength of a received telephone call is represented as λ, has a length of λ/4, a coaxial line having one end electrically connected to the other terminal of the relay unit, and a first ferrite core that is provided at a position away from the other terminal of the relay unit to which the one end of the coaxial line is connected by a length of about λ/4, and through which the coaxial line penetrates or is wound around.

The line conductor of the antenna element connected to the one terminal of the relay unit may be electrically connected to a core line of the coaxial wire at the relay unit.

The line conductor of the antenna element may have an axial direction of the spiral that is the same as the axial direction of the coaxial wire.

The cobra antenna may further include a second ferrite core for cutting off high-frequency current from the coaxial wire prior to a connector in a receiver to which the other end of the coaxial wire 5 is connected, wherein the second ferrite core has a high impedance to high-frequency waves, and through which the coaxial line penetrates or is wound around.

### Advantageous Effects of Invention

According to the present invention, a wide frequency band antenna, for example from the FM band to the UHF band, can be provided that is compact and that does not need to be precisely manufactured.

### BRIEF DESCRIPTION OF DRAWINGS

FIG. 1 is an explanatory diagram illustrating an example of a conventional type cobra antenna.

FIG. 2 is an explanatory diagram illustrating a configuration example of a cobra antenna according to a first embodiment of the present invention.

FIG. 3 is a graph and a series of tables illustrating the measurement results of peak gain in the UHF band of a conventional type cobra antenna.

FIG. 4 is a graph and a series of tables illustrating the measurement results of peak gain in the UHF band of a cobra antenna according to a first embodiment of the present invention.

FIG. 5 is an explanatory diagram illustrating a modified example of the cobra antenna of FIG. 2.

FIG. 6 is an explanatory diagram illustrating a configuration example of a cobra antenna according to a second embodiment of the present invention.

FIG. 7 is a graph and a series of tables illustrating the measurement results of peak gain in the FM/VHF band of a conventional type cobra antenna.

FIG. 8 is a graph and a series of tables illustrating the measurement results of peak gain in the FM/VHF band of a cobra antenna according to a second embodiment of the present invention.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

The description will be given in the following order.

1. Basic configuration example of a conventional type (cobra antenna example)

2. First embodiment (antenna element: example using a plate-shaped conductor)

3. Second embodiment (antenna element: example using a metal wire having a helical structure)

### 1. Basic Configuration Example of a Conventional Type

First, the antenna according to the present invention will be described regarding a conventional type cobra antenna.

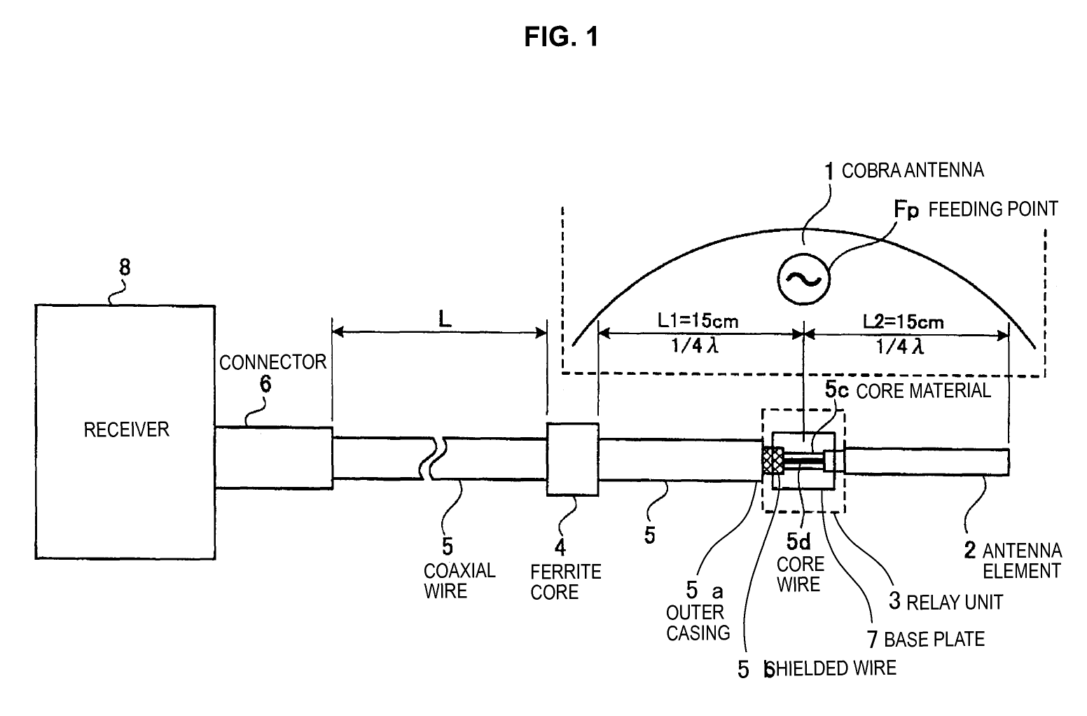

FIG. 1 is an explanatory diagram illustrating an example of a conventional type cobra antenna. The conventional type cobra antenna operates based on the same principles as the cobra antenna described in Non-Patent Literature 1.

The cobra antenna 1 illustrated in FIG. 1 includes an antenna element 2 with a length of λ/4 (wherein λ is the wavelength of the received radio waves), a relay unit 3 as a feeding point, a coaxial wire 5 (coaxial cable) connected to the relay unit 3, and a ferromagnetic ferrite core 4. The length of the coaxial wire 5 from the relay unit 3 to the ferrite core 4 is the same as the antenna element 2, λ/4. Note that although a coaxial cable having a part of its core wire exposed is used here as the antenna element 2, often the antenna element 2 is configured only from a line conductor.

One end of the coaxial wire 5 is connected to the antenna element 2 via the relay unit 3. Further, the coaxial wire 5 is wound around the ferrite core 4 about one to three times at a position that is λ/4 in the direction of the other end from the relay unit 3. Here, as a connector 6, it is preferred to select a connector that has little high-frequency signal loss. Further, a coaxial wire having the same configuration as the coaxial wire 5 is used as the antenna element 2 illustrated in FIG. 1.

In the relay unit 3, an outer casing (protective coating) 5a and a shielded wire (outer conductor) 5b of the coaxial wire 5 are cut away, so that a core material 5c (inductor) is exposed. Further, a core wire 5d of the coaxial wire 5 is connected, for example by soldering, to the core wire of the antenna element 2 at the relay unit 3. This relay unit 3 is molded on a base plate 7. The relay unit 3 serves as a feeding point Fp of the cobra antenna 1.

Based on such a configuration, in the cobra antenna 1, a choke coil is formed by the ferrite core 4 and the coaxial wire 5 wound around the ferrite core 4, so that a feeder section is electrically cut off from the ferrite core 4 to the connector 6. Consequently, a λ/2 dipole antenna is configured from the coaxial wire 5 (length λ/4) and the antenna element 2 (length λ/4) from the relay unit 3 (feeding point Fp) to the ferrite core 4. This dipole antenna can be simply installed by attaching an oval glass or the like on a portion of the core wire 5d on an upper side of the dipole antenna to insulate the antenna, and hanging the antenna from a branch of a tree or a wooden frame. Further, the thus-configured cobra antenna 1 can also be used as an antenna for a communications device installed in a vehicle or for a mobile device.

For example, a case will now be considered that enables the reception of broadcast waves in the UHF band frequency, for example 500 MHz, that is used for One Seg broadcasting by a car navigation device mounted in a vehicle. Since the wavelength λ of the broadcast waves is about 60 cm, a UHF band antenna can be configured by adjusting a length L1 of the coaxial wire 5 from the feeding point Fp to λ/4=15 cm and a length L2 of the antenna element 2 to λ/4=15 cm. The length L of the coaxial wire 5 from the ferrite core 4 to the connector 6 can be arbitrarily determined based on the choke coil effects of the ferrite core 4.

### 2. First Embodiment

### Antenna Configuration Example

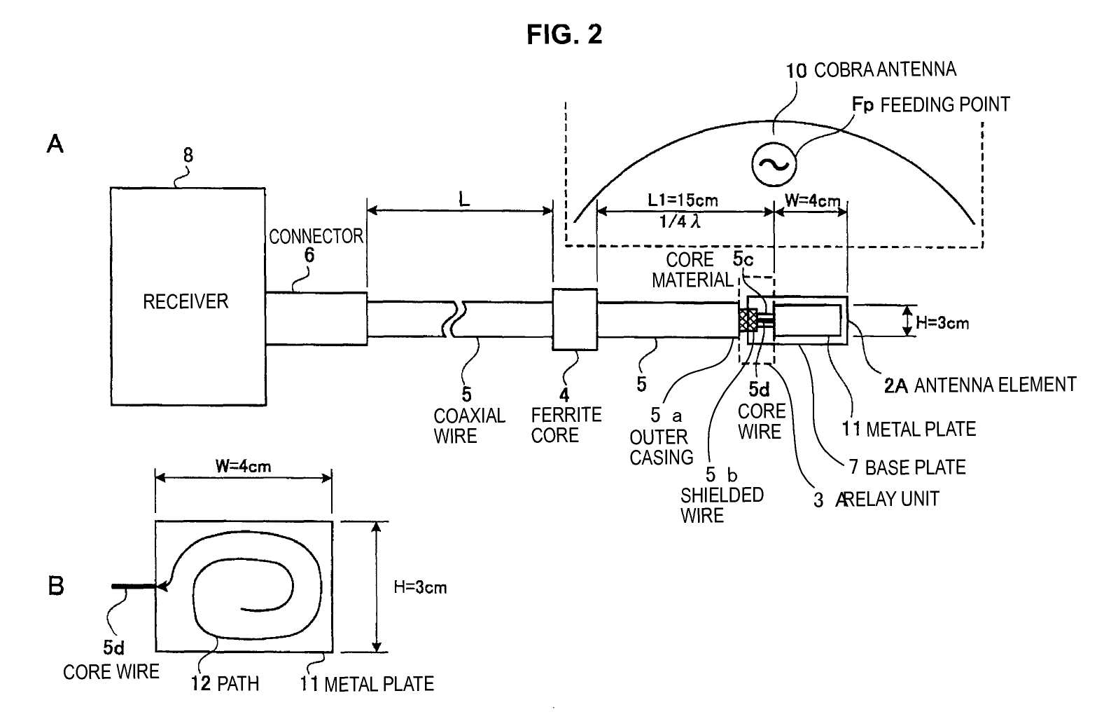

FIGS. 2A and 2B are explanatory diagrams illustrating a configuration example of a cobra antenna according to a first embodiment of the present invention. A detailed description of the portions in FIG. 2A corresponding to FIG. 1 will be omitted.

As illustrated in FIG. 2A, a cobra antenna 10 according to the first embodiment includes an antenna element 2A, a relay unit 3A as a feeding point, a coaxial wire 5 connected to the relay unit 3A, and a ferrite core 4. The length of the coaxial wire 5 from the relay unit 3A to the ferrite core 4 is λ/4.

One end of the coaxial wire 5 is connected to the antenna element 2A via the relay unit 3A. Further, the coaxial wire 5 is wound around the ferrite core 4 about one to three times at a position that is λ/4 in the direction of the other end from the relay unit 3A. The other end is connected to a connector 6 in a receiver 8. If the coaxial wire 5 is would only one time, this generally indicates that the coaxial wire 5 penetrates through the ferrite core 4. In this case, to fix the coaxial wire 5 at that location, the coaxial wire 5 is either molded with a resin or is fixed by a case.

The antenna element 2A is configured by fixing a flat metal plate (plate-shaped conductor) 11 to the base plate 7, and encasing the structure. A metal material with good conduction properties is used for the metal base plate 11. A core wire 5d of the coaxial wire 5 is connected, for example by soldering, to the metal base plate 11 of the antenna element 2A at the relay unit 3A. This relay unit 3A is molded on a base plate 7. The relay unit 3A serves as a feeding point Fp of the cobra antenna 10.

The shape and size of the metal base plate 11 can be appropriately determined based on the frequency (wavelength) of the received radio waves and the actual antenna characteristics. For example, when receiving 500 MHz broadcast waves in the UHF band, as illustrated in FIG. 2B, the metal base plate 11 can be a rectangle 4 cm wide and 3 cm high, for example. If formed as a rectangle 4 cm wide and 3 cm high, a length that is essentially λ/4 (15 cm) can be obtained as the length of a path 9a of up to the point where the current (charge) generated in the metal base plate 11 when 500 MHz radio waves are received flows into the core wire 5d. However, considering the electrical properties, such as how easily current flows, it is desirable for the metal plate to have a rectangular shape that is long in the length direction of the antenna (axial direction of the coaxial wire 5). Note that the path 9a illustrated in FIG. 2B is an example. The current may flow along some other more complex path.

Using the metal base plate 11 for the antenna element 2A enables an antenna that conventionally needed a 30 cm antenna length to be configured as an antenna with a length of 19 cm (=15 cm+4 cm) in the present embodiment.

[Verification of Antenna Characteristics]

The reception performance of the conventional type cobra antenna 1 and the cobra antenna 10 according to the first embodiment was compared.

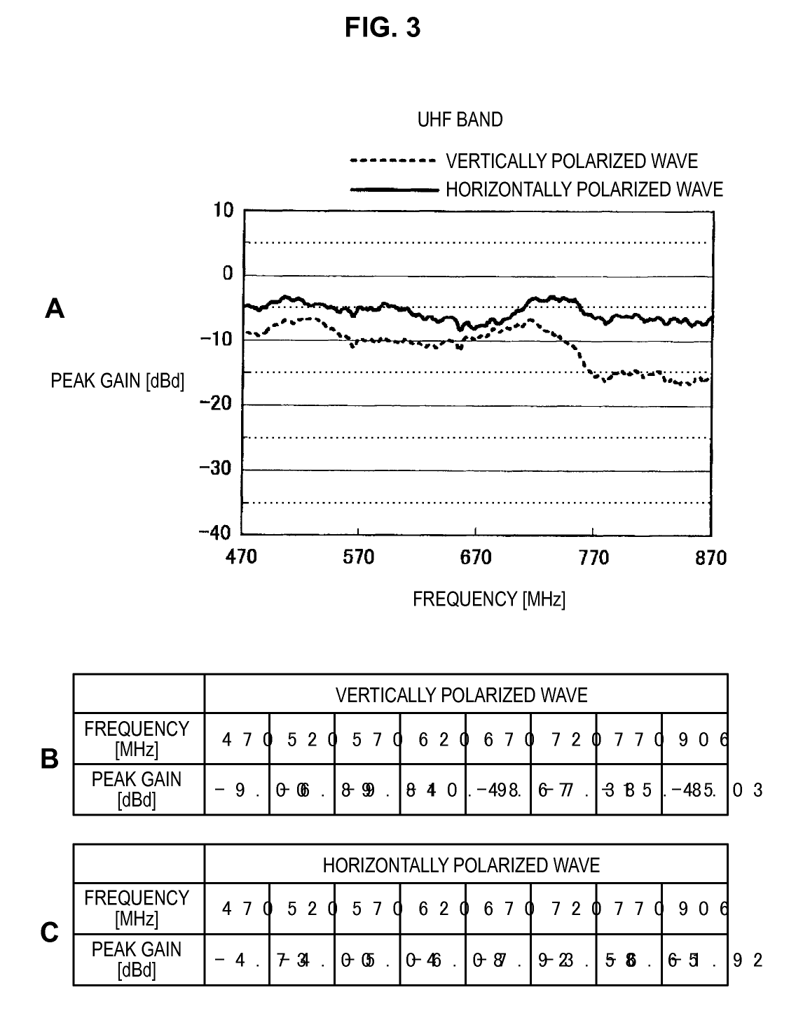

FIG. 3A is a graph illustrating the peak gain of a vertically polarized wave and a horizontally polarized wave for the conventional type cobra antenna 1 (refer to FIG. 1). The horizontal axis represents frequency (MHz), and the vertical axis represents peak gain (dBd). The measurement target frequency band was the UHF band (470 MHz to 870 MHz). The vertically polarized wave is shown by the dotted line, and the horizontally polarized wave is shown by the solid line. FIGS. 3B and 3C show the values for each measurement point in the graph of FIG. 3A. FIG. 3B shows the peak gain value for the vertically polarized wave, and FIG. 3C shows the peak gain value for the horizontally polarized wave. Further, FIGS. 3B and 3C also show a measurement value at 906 MHz, which is not in the graph of FIG. 3A.

As illustrated in FIGS. 3A and 3B, near 500 MHz, the peak gain value for both the vertically polarized wave and the horizontally polarized wave is −10 dBd or less, so that it can be seen that an antenna gain is obtained. Specifically, it can be said that the vertically polarized wave and the horizontally polarized wave are both received in the UHF band.

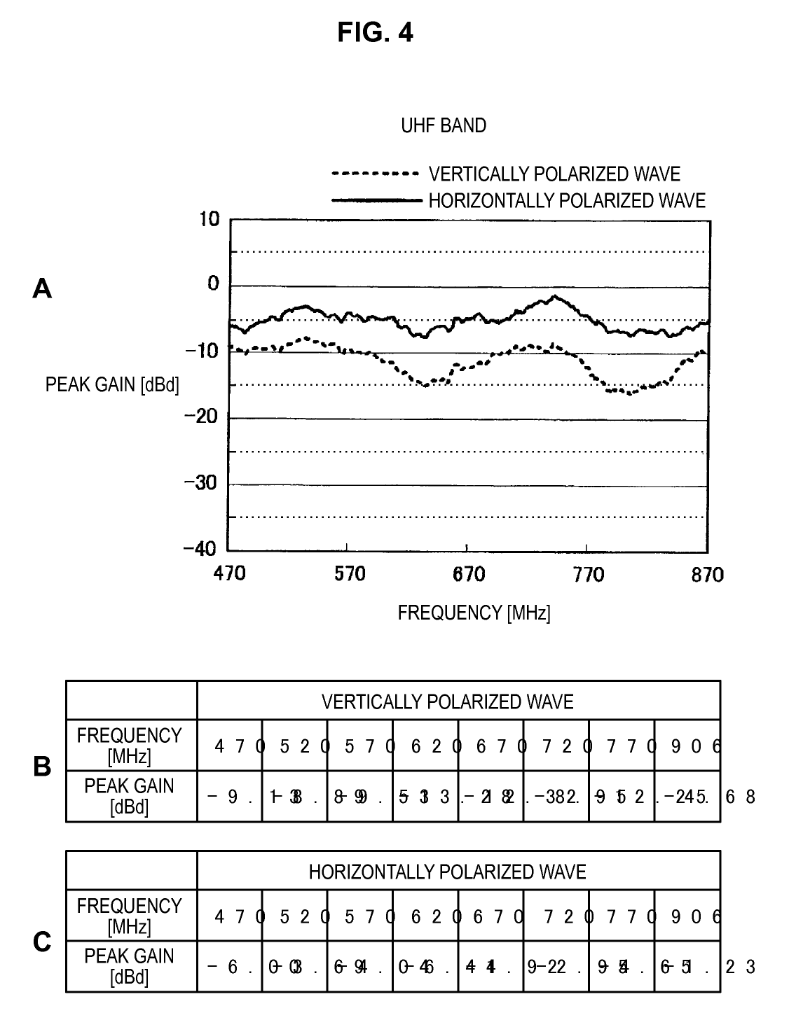

FIG. 4A is a graph illustrating the peak gain of a vertically polarized wave and a horizontally polarized wave for the cobra antenna 10 according to the present embodiment (refer to FIG. 10). The horizontal axis represents frequency (MHz), and the vertical axis represents peak gain (dBd). The measurement target frequency band was the same UHF band (470 MHz to 870 MHz) as in FIG. 3A. Further, FIGS. 4B and 4C show the values for each measurement point in the graph of FIG. 4A. FIG. 4B shows the peak gain value for the vertically polarized wave, and FIG. 4C shows the peak gain value for the horizontally polarized wave.

As illustrated in FIGS. 4A and 4B, near the adjustment target of 500 MHz, the peak gain value for both the vertically polarized wave and the horizontally polarized wave is −10 dBd or less, so that it can be seen that an antenna gain is obtained. Depending on the frequency band, there are even some portions where a greater antenna gain was obtained than for the conventional type cobra antenna 1. Specifically, it can be said that the antenna according to the present embodiment can receive both the vertically polarized wave and the horizontally polarized wave in the UHF band, and can obtain a performance equal to or better than the conventional type even though the antenna is very small.

### Modified Example

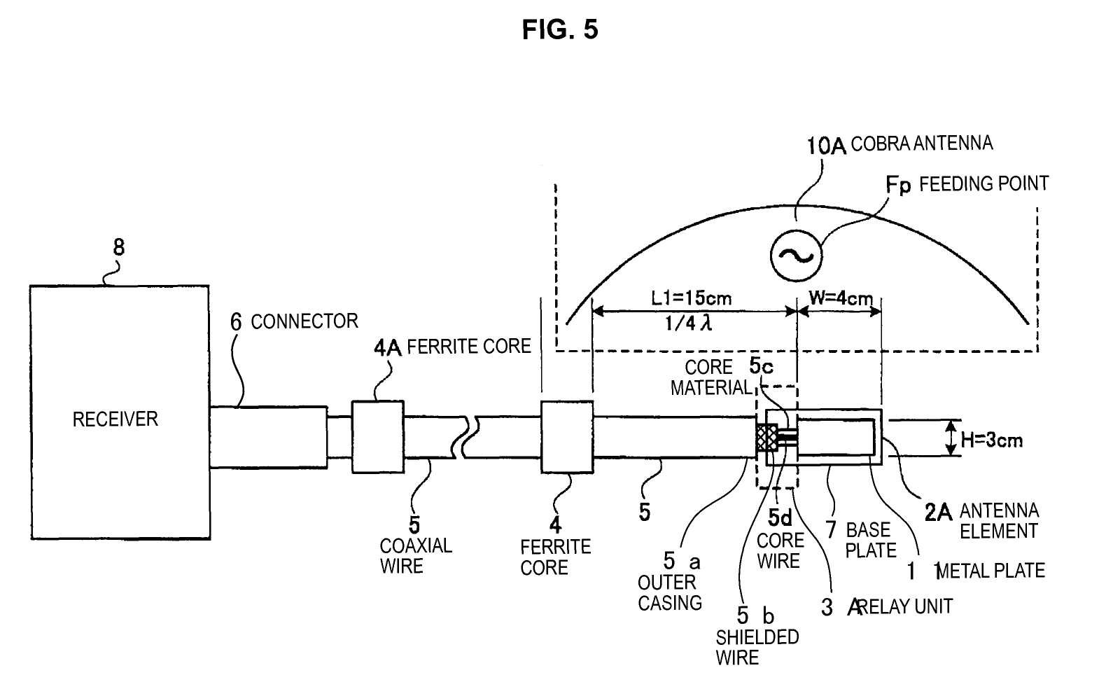

FIG. 5 is an explanatory diagram illustrating a cobra antenna having an additional ferrite core in the cobra antenna 10 (one core) illustrated in FIG. 2, for a total of two ferrite cores.

If the cobra antenna 10 illustrated in FIG. 2 is used as a wide frequency band antenna from the FM band to the UHF band, for example, radio wave interference can occur based on the length of the coaxial wire 5 from the ferrite core 4 to the receiver 8. Specifically, radio wave interference occurs in which the high-frequency current received by the coaxial wire 5 in the section on the upper side extending from the ferrite core 4 to the feeding point Fp leaks into the coaxial wire 5 on the lower side connected to the receiver 8 from the ferrite core 4. This leakage of high-frequency current, which can cause a deterioration in the gain characteristic as an antenna, can occur due to an impedance mismatch between the upper side and the lower side of the ferrite core 4.

Since this occurrence of high-frequency current leakage depends on the length of the coaxial wire 5 connected to the receiver 8 from the ferrite core 4, there are strict restrictions on how the length of the coaxial wire 5 in this section may be determined. Therefore, an extra ferrite core could be added to the cobra antenna 10 illustrated in FIG. 2 (one core) so that the cobra antenna has two ferrite cores.

In the cobra antenna 10A (two cores) illustrated in FIG. 5, a second ferrite core 4A is provided at a position near the receiver 8. This ferrite core 4A exhibits a high impedance to high-frequency waves. Consequently, a high-frequency current leaking from the antenna no longer propagates to the receiver 8 side. It is desirable for the position of the second ferrite core 4A to be close to the connector 6 of the receiver 8. In the cobra antenna 10A according to the present embodiment, the second ferrite core 4A is inserted directly in front of the connector 6 of the receiver 8. The coaxial wire 5 may be connected to the connector 6 either by simply passing it through a hole in the second ferrite core 4A, or after winding it about two to three times around the ferrite core 4A.

Thus, in the cobra antenna 10A according to the present embodiment, a second ferrite core 4A is arranged in front of the connector 6, so that the receiver 8 side has a high impedance to high-frequency current that is picked up by the coaxial wire 5 connecting the connector 6 with the ferrite core 4. Consequently, even if the coaxial wire 5 from the first ferrite core 4 to the connector 6 picks up leaked high-frequency current, that leaked high-frequency current is cut off by the ferrite core 4A, and does not have an adverse effect on the receiver 8 side.

### Advantages of the First Embodiment

According to the above-described embodiment, by using a metal plate (plate-shaped conductor) as an antenna element and appropriately designing the surface area of that metal plate, the current path length needed for radio wave reception is obtained. Consequently, the length of the antenna element is kept to a length of about λ/4 of the wavelength of the received radio waves, thus enabling a compact antenna to be realized. Further, the compact size of the antenna enables the arrangement area to be reduced and convenience to be improved (easy installation). In addition, since the antenna element is configured from a single metal plate, a high level of manufacturing precision is not needed. Moreover, the antenna according to the present embodiment can also maintain its antenna characteristics while realizing a reduction in size.

Note that although an antenna configuration was described in the above embodiment that was based on the reception of UHF band radio waves, obviously an antenna configured from a single metal plate can also be used even when receiving FM/VHF band radio waves.

### 3. Second Embodiment

### Antenna Configuration Example

Next, as a second embodiment of the present invention, a cobra antenna configuration example will be described that uses a line conductor having a helical structure for the antenna element, rather than a metal plate.

When receiving radio waves of 100 MH in the VHF band using the cobra antenna 10A (refer to FIG. 5) according to the modified example of the first embodiment, since the wavelength λ of such radio waves is 3 m, the length L2 of the antenna element needs to be 75 cm. Thus, an antenna for VHF band reception will be configured from an antenna element of 75 cm and a coaxial wire outer casing of 75 cm. However, in order to function as an antenna, since the portion functioning as the antenna needs to be configured so as to not overlap the section between the antenna element and the outer casing of the coaxial wire, even more than for UHF band reception, there are many restrictions on the installation location. Therefore, in the second embodiment, the antenna length is shortened using a line conductor for the antenna element.

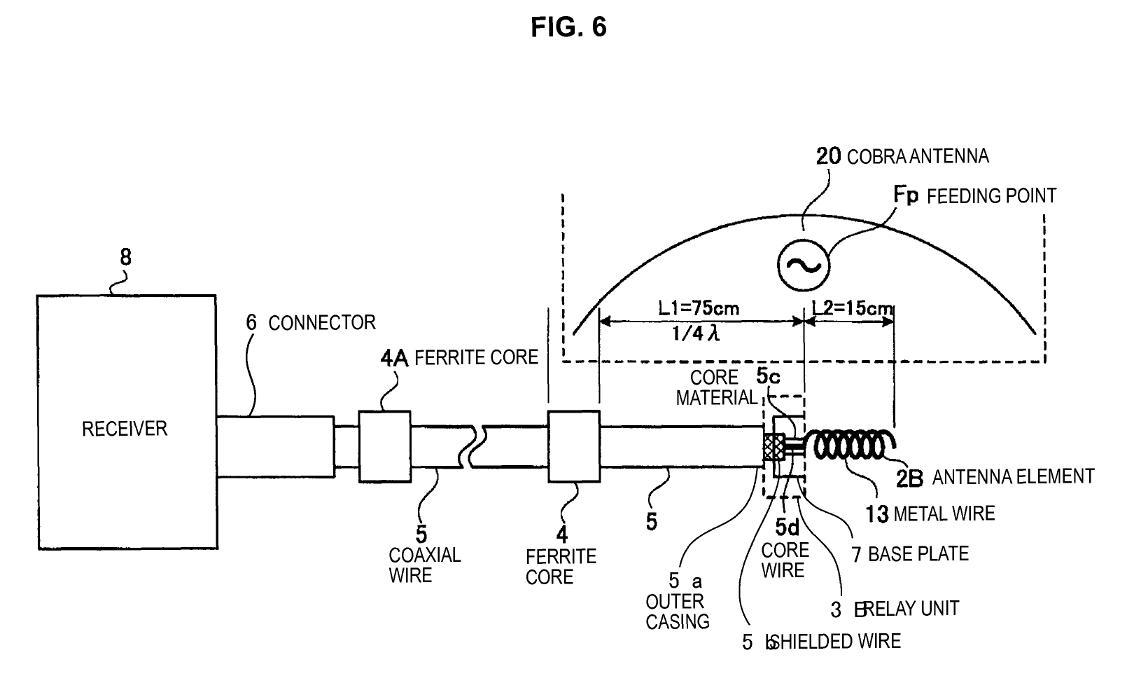

FIG. 6 is an explanatory diagram illustrating a configuration example of a cobra antenna according to the second embodiment of the present invention. A detailed description of the portions in FIG. 6 corresponding to FIG. 5 will be omitted.

As illustrated in FIG. 6, an antenna element 2B is configured using a metal wire 13, which is a line conductor, wound in a spiral. One end of the metal wire 13 is left open, and the other end is connected, for example by soldering, to the core wire 5d of the coaxial wire 5 at a relay unit 3B. This relay unit 3B is molded on a base plate 7. The relay unit 3B serves as a feeding point Fp of the cobra antenna 10B. The axial direction of the spiral of the spiral-shaped metal wire 13 is the same as the axial direction of the coaxial wire 5.

The antenna element 2B formed by winding the metal wire 13 with a length of 75 cm in a spiral shape with a diameter of 10 mm and then encasing the structure enables an antenna that conventionally needed a 1.5 m length in the long direction to be configured with a length of 0.9 m (=0.75 m+0.15 m). Note that the diameter of the spiral formed by the metal wire is not limited to 10 mm.

[Verification of Antenna Characteristics]

The reception performance of the conventional type cobra antenna 1 and the cobra antenna 10B according to the second embodiment was compared.

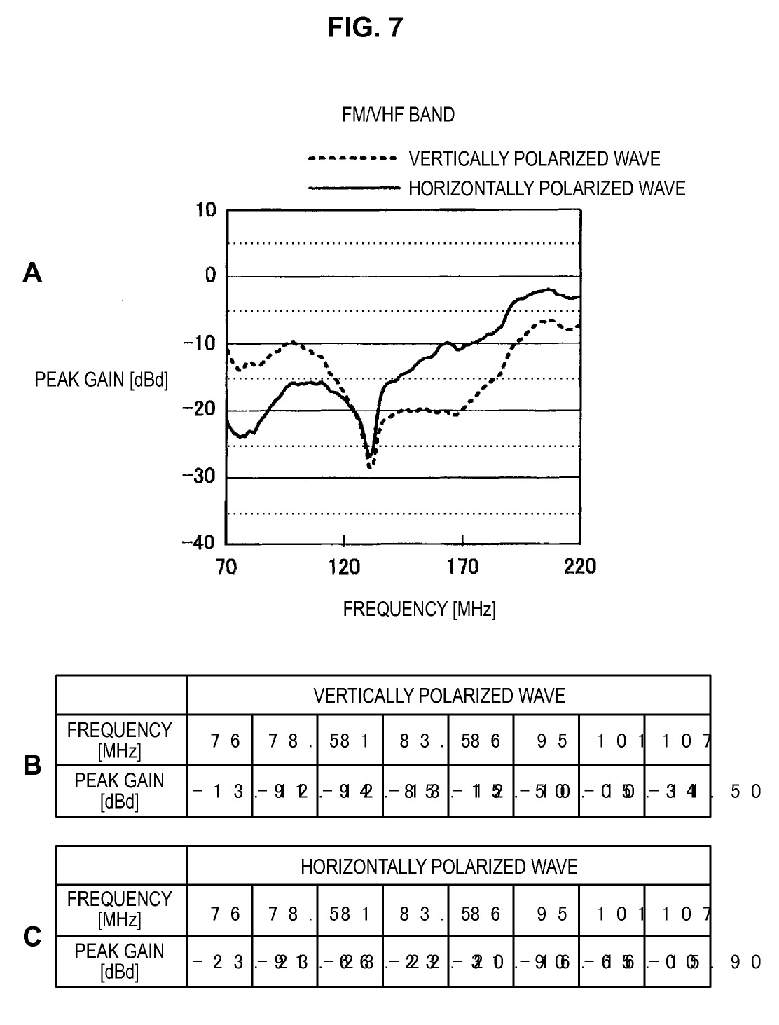

FIG. 7A is a graph illustrating the peak gain of a vertically polarized wave and a horizontally polarized wave for the conventional type cobra antenna 1. The horizontal axis represents frequency (MHz), and the vertical axis represents peak gain (dBd). The measurement target frequency band was the FM/VHF band (70 MHz to 220 MHz). The vertically polarized wave is shown by the dotted line, and the horizontally polarized wave is shown by the solid line. FIGS. 7B and 7C show the values for each measurement point in the graph of FIG. 7A. FIG. 7B shows the peak gain value for the vertically polarized wave, and FIG. 7C shows the peak gain value for the horizontally polarized wave. Further, FIGS. 7B and 7C only show the measurement values for the frequencies between 76 MHz and 107 MHz from among the frequencies shown on the horizontal axis of FIG. 7A.

As illustrated in FIGS. 7A and 7B, near 100 MHz, the peak gain for the vertically polarized wave is −10.34 dBd at 101 MHz. The peak gain for the horizontally polarized wave is, as illustrated in FIGS. 7A and 7C, −16.00 dBd at 101 MHz. Specifically, near 100 MHz, the peak gain for the horizontally polarized wave is −15 dBd or less, so that the reception state of the horizontal polarized wave is comparatively good.

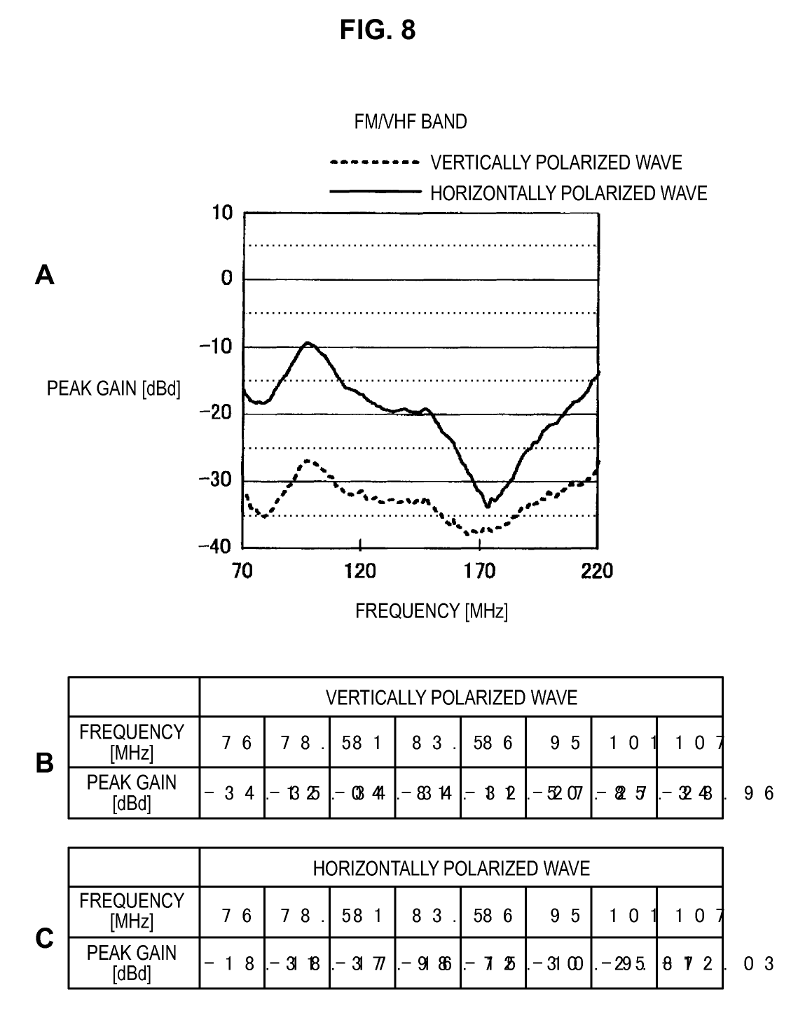

FIG. 8A is a graph illustrating the peak gain of a vertically polarized wave and a horizontally polarized wave for the cobra antenna 10B according to the present embodiment (refer to FIG. 6). The measurement target frequency band was the same FM/VHF band (70 MHz to 220 MHz) as in FIG. 7A. Further, FIGS. 8B and 8C show the values for each measurement point in the graph of FIG. 8A. FIG. 8B shows the peak gain value for the vertically polarized wave, and FIG. 8C shows the peak gain value for the horizontally polarized wave.

As illustrated in FIGS. 8A and 8B, near 100 MHz, the peak gain for the vertically polarized wave is −27.34 dBd at 101 MHz. The peak gain for the horizontally polarized wave is, as illustrated in FIGS. 8A and 8C, −9.87 dBd at 101 MHz. Specifically, near 100 MHz, the peak gain for the horizontally polarized wave is −15 dBd or less, so that the reception state of the horizontal polarized wave is comparatively good. The reason why the direction of the received radio waves is different in the graph of FIG. 8A and the graph of FIG. 7A is because of a difference in how the antenna was placed during measurement.

Based on these measurement results, it can be seen that although the direction of the received radio waves is different, the antenna according to the present embodiment has about the same level of antenna gain for a horizontally polarized wave as the conventional type antenna has for a vertically polarized wave. Therefore, the antenna according to the present embodiment can obtain a performance equal to or better than the conventional type in the FM/VHF band even though the antenna is very small.

### Advantages of the Second Embodiment

According to the above-described embodiment, by using a metal wire (line conductor) as an antenna element and forming the metal wire in a spiral shape, the current path length needed for radio wave reception is obtained. Consequently, the length of the antenna element is kept to a length of about λ/4 of the wavelength of the received radio waves, thus enabling a compact antenna to be realized. Further, the compact size of the antenna enables the arrangement area to be reduced and convenience to be improved (easy installation). In addition, since the antenna element is configured by forming the metal wire in a spiral shape, a high level of manufacturing precision is not needed. Moreover, the antenna according to the present embodiment can also maintain its antenna characteristics while realizing a reduction in size.

Further, although the antenna according to the present invention was applied in a cobra antenna, since the antenna element was merely replaced with that according to the present invention, the antenna is not limited to this example. The antenna according to the present invention may be applied in some other monopole antenna or dipole antenna, for example.

In addition, although an antenna was described in which the antenna element was configured from a metal plate (plate-shaped conductor) or a metal wire (line conductor), the same advantageous effects can also be exhibited with some other member, such as a film-shaped conductor or a flexible conductor.

Moreover, in the above-described embodiments, although an example was described in which the antenna was mounted in a vehicle, other than in a vehicle, the antenna according to the present invention can obviously also be used in indoor devices.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

Additionally, the present technology may also be configured as below.

(1)

A cobra antenna including:

a relay unit forming a feeding point;

an antenna element formed from a plate-like conductor that is electrically connected to one terminal of the relay unit and, when a wavelength of radio waves is represented as λ, has a surface area capable of obtaining a length of λ/4 as a path through which a current generated by reception of the radio waves flows to the one terminal of the relay unit;

a coaxial line having one end electrically connected to the other terminal of the relay unit; and

a first ferrite core that is provided at a position away from the other terminal of the relay unit to which the one end of the coaxial line is connected by a length of about λ/4, and through which the coaxial line penetrates or is wound around.

(2)

The cobra antenna according to claim 1, wherein the plate-shaped conductor of the antenna element connected to the one terminal of the relay unit is electrically connected to a core line of the coaxial wire at the relay unit.

(3)

The cobra antenna according to claim 2, wherein the plate-shaped conductor of the antenna element has a rectangular shape that is long in an axial direction of the coaxial wire.

(4)

The cobra antenna according to claim 3, further including a second ferrite core for cutting off high-frequency current from the coaxial wire prior to a connector in a receiver to which the other end of the coaxial wire is connected,

wherein the second ferrite core has a high impedance to high-frequency waves, and through which the coaxial line penetrates or is wound around.

(5)

A cobra antenna including:

a relay unit forming a feeding point;

an antenna element formed from a spiral-shaped line conductor that is electrically connected to one terminal of the relay unit and, when a wavelength of a received telephone call is represented as λ, has a length of λ/4;

a coaxial line having one end electrically connected to the other terminal of the relay unit; and

a first ferrite core that is provided at a position away from the other terminal of the relay unit to which the one end of the coaxial line is connected by a length of about λ/4, and through which the coaxial line penetrates or is wound around.

(6)

The cobra antenna according to claim 5, wherein the line conductor of the antenna element connected to the one terminal of the relay unit is electrically connected to a core line of the coaxial wire at the relay unit.

(7)

The cobra antenna according to claim 6, wherein the line conductor of the antenna element has an axial direction of the spiral that is the same as the axial direction of the coaxial wire.

(8)

The cobra antenna according to claim 7, further including a second ferrite core for cutting off high-frequency current from the coaxial wire prior to a connector in a receiver to which the other end of the coaxial wire is connected,

wherein the second ferrite core has a high impedance to high-frequency waves, and through which the coaxial line penetrates or is wound around.

### REFERENCE SIGNS LIST

2, 2A, 2B Antenna element
3, 3A, 3B Relay unit
4, 4A Ferrite core
5 Coaxial wire
5a Outer casing
5b Shielded wire
5c Core material
5d Core wire
7 Base plate
9 Metal plate
9a Path
10, 10A, 10B Cobra antenna

1. A cobra antenna comprising:
a relay unit forming a feeding point;
an antenna element formed from a plate-like conductor that is electrically connected to one terminal of the relay unit and, when a wavelength of radio waves is represented as λ, has a surface area capable of obtaining a length of λ/4 as a path through which a current generated by reception of the radio waves flows to the one terminal of the relay unit;
a coaxial line having one end electrically connected to the other terminal of the relay unit; and
a first ferrite core that is provided at a position away from the other terminal of the relay unit to which the one end of the coaxial line is connected by a length of about λ/4, and through which the coaxial line penetrates or is wound around.

2. The cobra antenna according to claim 1, wherein the plate-shaped conductor of the antenna element connected to the one terminal of the relay unit is electrically connected to a core line of the coaxial wire at the relay unit.

3. The cobra antenna according to claim 2, wherein the plate-shaped conductor of the antenna element has a rectangular shape that is long in an axial direction of the coaxial wire.

4. The cobra antenna according to claim 3, further comprising a second ferrite core for cutting off high-frequency current from the coaxial wire prior to a connector in a receiver to which the other end of the coaxial wire is connected,
wherein the second ferrite core has a high impedance to high-frequency waves, and through which the coaxial line penetrates or is wound around.

5. A cobra antenna comprising:
a relay unit forming a feeding point;
an antenna element formed from a spiral-shaped line conductor that is electrically connected to one terminal of the relay unit and, when a wavelength of a received telephone call is represented as λ, has a length of λ/4;
a coaxial line having one end electrically connected to the other terminal of the relay unit; and
a first ferrite core that is provided at a position away from the other terminal of the relay unit to which the one end of the coaxial line is connected by a length of about λ/4, and through which the coaxial line penetrates or is wound around.

6. The cobra antenna according to claim 5, wherein the line conductor of the antenna element connected to the one terminal of the relay unit is electrically connected to a core line of the coaxial wire at the relay unit.

7. The cobra antenna according to claim 6, wherein the line conductor of the antenna element has an axial direction of the spiral that is the same as the axial direction of the coaxial wire.

8. The cobra antenna according to claim 7, further comprising a second ferrite core for cutting off high-frequency current from the coaxial wire prior to a connector in a receiver to which the other end of the coaxial wire is connected,
wherein the second ferrite core has a high impedance to high-frequency waves, and through which the coaxial line penetrates or is wound around.
